(19) United States
(12) Patent Application Publication
(10) Pub. No.: US 2023/0036431 A1
(43) Pub. Date: Feb. 2, 2023

(54) BLOOM COMPENSATION IN A LIGHT DETECTION AND RANGING (LiDAR) SYSTEM

(71) Applicant: Seagate Technology LLC, Fremont, CA (US)

(72) Inventors: Daniel Joseph Klemme, Robbinsdale, MN (US); Eric James Dahlberg, Eden Prairie, MN (US)

(21) Appl. No.: 17/841,854

(22) Filed: Jun. 16, 2022

Related U.S. Application Data
(60) Provisional application No. 63/216,658, filed on Jun. 30, 2021.

(51) Int. Cl. G01S 7/486; G01S 7/481; G01S 7/484; G01S 17/10

(52) U.S. Cl. CPC G01S 7/486; G01S 7/4817; G01S 7/484; G01S 17/10

(57) ABSTRACT

Method and apparatus for detecting and compensating for highly reflective targets such as retroreflectors in a light detection and ranging (LiDAR) system. In some embodiments, a bloom event (response) is detected in a detector output in response to the transmission and reflection of emitted light pulses against a target. A beam width of the emitted light pulses on the target is determined. The beam width is used to compensate at least a portion of the bloom response to obtain range information associated with the target. In this way, bloom compensation is provided without shutting down the capabilities of the LiDAR system in detecting the target causing the bloom, as well as in detecting other targets in the field of view.

### RELATED APPLICATION

The present application makes a claim of domestic priority to U.S. Provisional Patent Application No. 63/216,658 filed Jun. 30, 2021, the contents of which are hereby incorporated by reference.

### SUMMARY

Various embodiments of the present disclosure are generally directed to a method and apparatus for providing bloom compensation in an active light detection system.

Without limitation, in some embodiments a bloom response is detected in a detector output in response to transmission and reflection of emitted light pulses against a target. A beam width of the emitted light pulses on the target is determined. The beam width is used to compensate at least a portion of the bloom response to obtain range information associated with the target. The bloom response may arise from the illumination of a highly reflective target, such as a retroreflector.

These and other features and advantages of various embodiments of the present disclosure can be understood with a review of the following detailed description section in conjunction with the accompanying drawings.

### BRIEF DESCRIPTION OF THE DRAWINGS

FIG. 1 is a block representation of a Light Detection and Ranging (LiDAR) system constructed and operated in accordance with various embodiments of the present disclosure.

FIGS. 2A through 2C show different configurations of retroreflectors in accordance with related art that can be detected and compensated using some embodiments.

FIGS. 3A and 3B show different forms of bloom responses that can be obtained by various embodiments of the present disclosure from retroreflectors such as depicted in FIGS. 2A-2C.

FIG. 4 is a simplified functional representation of an emitter constructed and operated in accordance with some embodiments.

FIGS. 5A and 5B show different output systems that can be incorporated into an emitter such as in FIG. 4.

FIG. 6 depicts a light source to illustrate a beam width in some embodiments.

FIG. 7 is a simplified detector system that can be used in accordance with some embodiments.

FIG. 8 shows an analysis circuit that can be incorporated into the detector system of FIG. 7.

FIG. 9 is a sequence diagram to illustrate operations that can be carried out by various embodiments of the present disclosure.

FIG. 10 is a simplified representation of a field of view output of a detector to illustrate operation of the sequence of FIG. 9 in some embodiments.

FIG. 11 is a functional block representation of a bloom response management system constructed and operated in accordance with further embodiments.

### DETAILED DESCRIPTION

Various embodiments of the present disclosure are generally directed to optimization of an active light detection system.

Light Detection and Ranging (LiDAR) systems are useful in a number of applications in which ranges (e.g., distances) from an emitter to a target are detected by irradiating the target with electromagnetic radiation in the form of light. The range is detected in relation to timing characteristics of reflected light received back by the system. LiDAR applications include topographical mapping, guidance, surveying, and so on. One increasingly popular application for LiDAR is in the area of autonomously piloted or driver assisted vehicle guidance systems (e.g., self-driving cars, autonomous drones, etc.). While not limiting, the light wavelengths used in a typical LiDAR system may range from ultraviolet to near infrared (e.g., 250 nanometers, nm to 1000 nm or more). Other wavelength ranges can be used.

One commonly employed form of LiDAR is sometimes referred to as coherent pulsed LiDAR, which generally uses coherent light and detects the range based on detecting phase differences in the reflected light. Such systems may use a dual (IQ) channel detector with an I (in-phase) channel and a Q (quadrature) channel. Other forms of LiDAR can be used, however, including non-coherent pulsed systems.

Further alternatives that can be incorporated into LiDAR systems include systems that sweep the emitted light using mechanical based systems that utilize moveable mechanical elements, or solid-state systems with no moving mechanical parts but instead use phase array mechanisms to sweep the emitted light in a direction toward the target. A point cloud in the form of a three-dimensional representation of the viewed environment can be generated from the LiDAR detected data.

While operable, these and other forms of LiDAR systems can have difficulty determining accurate range information when highly reflective targets are encountered. More particularly, a phenomenon sometimes referred to as bloom can degrade the performance of a LiDAR system.

Generally, the term bloom refers to an enhanced response that is received from a LiDAR emission. Bloom results in blurriness, saturation or other adverse responses if excessive light is reflected from a target. As used herein, bloom can describe a number of related concepts such as glare, glow, lens flare, oversaturation, etc.

Bloom can be mathematically defined as a returned light saturation level that is above a predetermined expected threshold. Under normal conditions, light that impinges a target and which is subsequently reflected back to the system will be backscattered, absorbed, diffused, etc. so that less than an expected amount of the emitted light will be received by a detector of the system.

However, in certain circumstances a significantly greater amount of light can be reflected, resulting in a bloom event. There are a number of reasons why a bloom event can occur, but usually one source is the detection of a so-called retroreflector element. As used herein, a retroreflector is a highly reflective element specifically configured to provide high levels of reflectivity in low light conditions. Examples of retroreflector elements include road signs, road markings, work vests, etc.

While useful to human optical systems in identifying such elements in low light conditions, these and other types of retroreflectors can wreak havoc on an LiDAR system since excessive levels of light may be received back from such elements, particularly for systems not calibrated or adapted to handle such reflection. While not necessarily limiting, many retroreflector elements are configured to reflect light back that is parallel to the incident light, irrespective of the initial incident light angle. As a result, it is possible to achieve reflected light that is 80%, 90%, 95%, 100% or (at least in some cases including cases where multiple channels of light are emitted) greater than 100% of the emitted light.

There is accordingly a need for improvements in the manner in which LiDAR systems detect and compensate for bloom events, including those caused by retroreflector elements.

Various embodiments of the present disclosure address these and other limitations of the existing art by providing a method and apparatus for identifying, evaluating and compensating for bloom events, including but not limited to bloom events caused by the impingement of a retroreflector element.

As explained below, some embodiments include a LiDAR system with a specially configured emitter and a specially configured detector. The system operates to provide range information based on detection of a distal target device.

In at least some embodiments, the system is configured to determine that a bloom event has been encountered. The system proceeds to determine if the bloom event is due to detection of a retroreflector or other highly reflective device. A beam width of the emitted light issued by the system is determined, and this beam width is used to identify contours associated with the detected target. Compensation efforts are taken to remove, mask out, or otherwise adjust system levels to compensate for the bloom event in order to obtain useful range data associated with the target that is causing the bloom event.

In this way, bloom compensation is provided without shutting down the capabilities of the LiDAR system in detecting the target causing the bloom as well as other targets in the field of view. Basically, a highly reflective object such as a retroreflector will tend to appear larger to the LiDAR system because the beam has a finite width and the tails on the beam may be detectable for such a target. So even when a beam is offset from the target, reflections from the target may still be detected. Knowledge of the beam width allows this to be compensated.

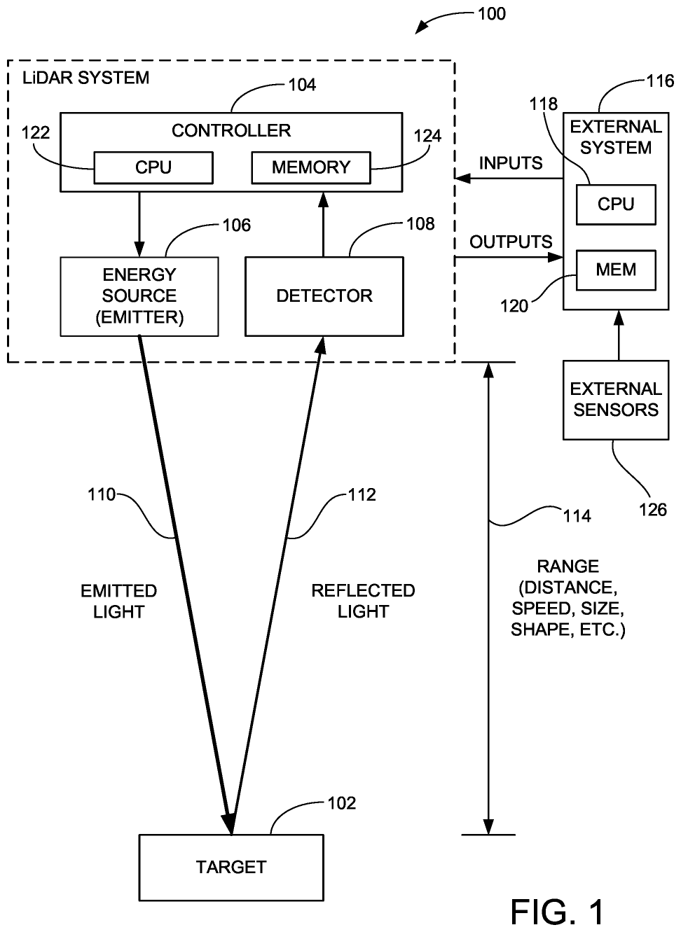

These and other features and advantages of various embodiments can be understood beginning with a review of FIG. 1, which provides a simplified functional representation of a LiDAR system 100 constructed and operated in accordance with various embodiments of the present disclosure. The LiDAR system 100 is configured to obtain range information regarding a target 102 that is located distal from the system 100. The information can be beneficial for a number of areas and applications including, but not limited to, topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses towards the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 perform these operations directly, or can communicate the range information to an external system 116 for further processing and/or use.

In some cases, inputs supplied by the external system 116 can activate and configure the system to capture particular range information, which is then returned to the external system 116 by the controller 104. The external system can take any number of suitable forms, and may include a system controller (such as CPU 118), local memory 120, etc. The external system may form a portion of a closed-loop control system and the range information output by the LiDAR system 100 can be used by the external system 116 to adjust the position of a moveable element.

The controller 104 can incorporate one or more programmable processors (CPU) 122 that execute program instructions in the form of software/firmware stored in a local memory 124, and which communicate with the external controller 118. External sensors 126 can provide further inputs used by the external system 116 and/or the LiDAR system 100.

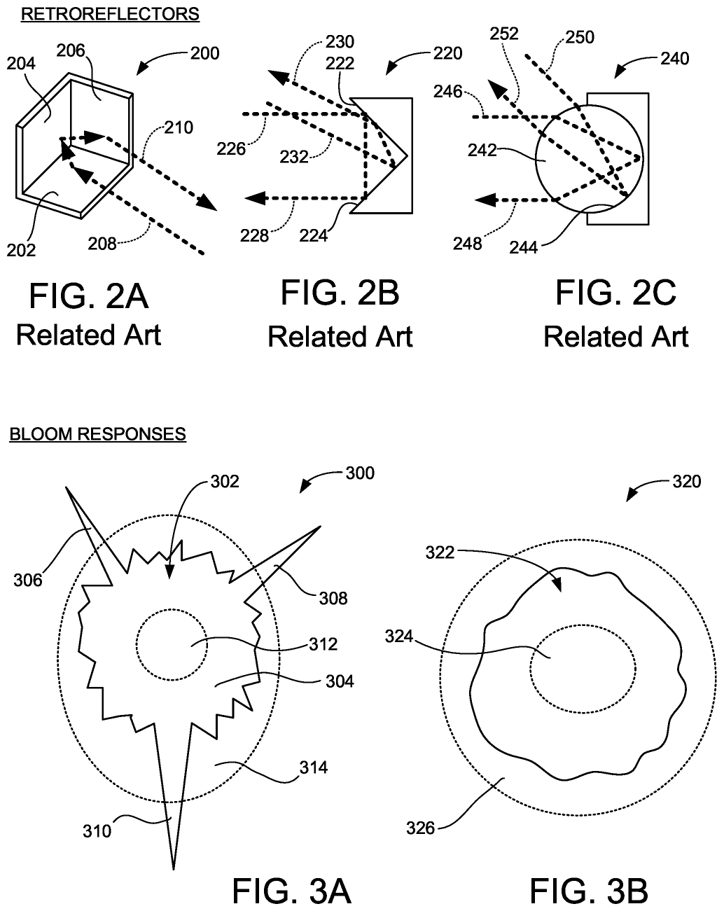

FIGS. 2A-2C illustrate different types of related art retroreflectors that can be encountered by a LiDAR system such as depicted in FIG. 1. It will be appreciated that other forms of retroreflectors can be used, so these representations are merely illustrative and are not limiting.

FIG. 2A is a 3D representation of a corner retroreflector 200 in accordance with some configurations. The retroreflector 200 includes orthogonal reflective surfaces 202, 204 and 206, each of which can be viewed as being aligned along different planes of an x-y-z coordinate system.

Incident light, represented by dashed line 208, impinges each of the respective surfaces 202, 204 and 206 in turn to provide a corresponding reflected light stream, represented by dashed line 210. Generally, the respective incident and reflected light streams 208, 210 are nominally parallel. This will be true for substantially any incident angle along any selected axis x, y or z of the emitted light; the corresponding reflected light, at least over a specified field of view, will be parallel to the incident light.

FIG. 2B is a 2D representation of another retroreflector 220 in accordance with some configurations. The retroreflector 220 includes interior orthogonal surfaces 222, 224. The retroreflector 220 can be a 3D corner element as in FIG. 2A, although such is not necessarily required.

As before, incident and reflected light are nominally parallel. One path of such light is denoted by dashed lines 226, 228; another path of such light is denoted by dashed lines 230, 232.

FIG. 2C is another 2D representation of a retroreflector 240, characterized as a cat eye reflector. The reflector 240 has a spherical or otherwise curvilinearly extending element 242, with a backing reflective coating 244. As before, incident and reflected light are nominally parallel, as depicted by light paths 246, 248 and 250, 252.

The size, scale and arrangement of retroreflector elements such as depicted in FIGS. 2A-2C can vary depending on the requirements of a given application. Usually, an array of such elements is arranged to provide a larger retroreflective surface, such as on protective clothing, reflective signs and street markings, emergency worker and construction area equipment, etc. For clarity, reference to retroreflectors and the like will be understood broadly to include devices that incorporate one or many such elements to provide a highly reflective surface.

As noted above, bloom is recognized in the art as a localized area of higher than normal/expected reflectivity, such as but not limited to a camera flare or other area of high saturation. FIGS. 3A and 3B have been provided to illustrate, in a general way, different types of bloom events that can be experienced and processed by the system 100 in FIG. 1 in accordance with some embodiments. FIGS. 3A and 3B represent the detector response using retroreflector elements such as depicted in FIGS. 2A-2C.

FIG. 3A shows a first bloom event 300, also sometimes referred to as a first bloom response or a discontinuous (e.g., spiky or jagged) response. A general area of enhanced reflectivity is denoted at 304. This area is generally circular in nature, although such is not necessarily required. Spikes, or elongated areas of enhanced reflectivity, may project from the central area 304, as denoted at 306, 308, 310. It will be noted that the actual size of the target generating the bloom response 300 may be significantly smaller, as denoted by area 312. The bloom response 300 will tend to be surrounded by a background area 314 that does not provide the enhanced reflectivity response of the rest of the bloom.

FIG. 3B shows a second bloom event 320, also sometimes referred to as a second bloom response or a continuous (e.g., smooth) response. Unlike the jagged features of the response 300 in FIG. 3A, the response 320 in FIG. 3B is relatively smooth and largely circular or otherwise continuously contoured as shown. As before, the actual size of the target inducing the bloom response 320 may be significantly smaller as represented at 324, and a surrounding area 326 has a step-wise reduction in reflectivity power.

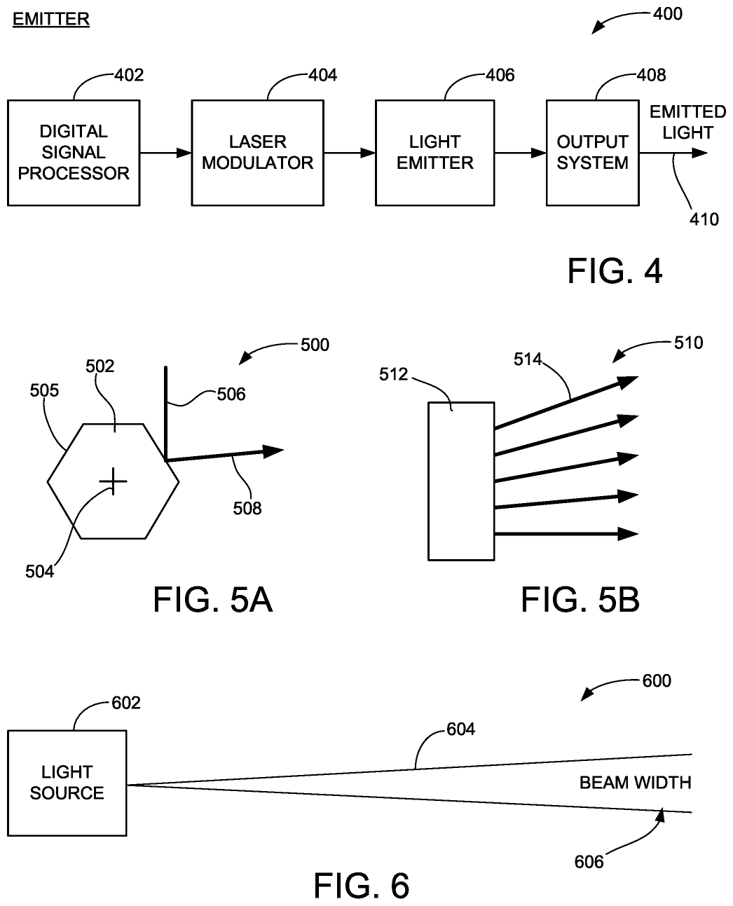

FIG. 4 depicts an emitter 400 constructed and operated in accordance with some embodiments, and which corresponds to the emitter 106 in FIG. 1. Other configurations for the emitter 400 can be used.

A digital signal processor (DSP) 402 provides control inputs to a laser modulator 404, which in turn directs a light emitter 406 (such as a laser, an LED, etc.) to emit, via a suitable output system 408, emitted light pulses 410. The output system 408 can take any variety of configurations including an electromechanical system, a solid state array, etc. Further aspects can include optics (e.g., one or more lenses, etc.). Multiple channels of beams can be supplied, the beams can be swept or otherwise directed in various angles over a selected field of view, and so on.

FIGS. 5A and 5B show different aspects of output systems that can be incorporated into various embodiments of the emitter 400 of FIG. 4. FIG. 5A shows a system 500 that includes a rotatable polygon 502 which is mechanically rotated about a central axis 504 at a desired rotational rate. The polygon 502 has reflective outer surfaces 505 adapted to direct incident light 506 as a reflected stream 508 at a selected angle responsive to the rotational orientation of the polygon 502.

FIG. 5B provides a system 510 with a solid state array (integrated circuit device) 512 configured to emit light beams 514 at various selected angles across a desired field of view. As noted above, other output system arrangements can be utilized as required, so these are merely illustrative and are not limiting.

FIG. 6 demonstrates a generalized system 600 in accordance with further embodiments. The system 600 corresponds to FIGS. 4-5 and includes a light source 602 that generates a beam of light 604. The light beam 604 can be continuous light emissions, pulses of light, fixed orientation beams, swept beams, etc. The light beam 604 can further be coherent light at a fixed frequency, a tight focal length, etc.

Regardless of configuration, it will be appreciated that the beam 604 will have a beam width 606, and this beam width will tend to expand in direct relation to the distance from the light source to the target. Various embodiments of the present disclosure use this beam width information in at least some aspects to compensate for bloom responses such as discussed above in FIGS. 3A and 3B.

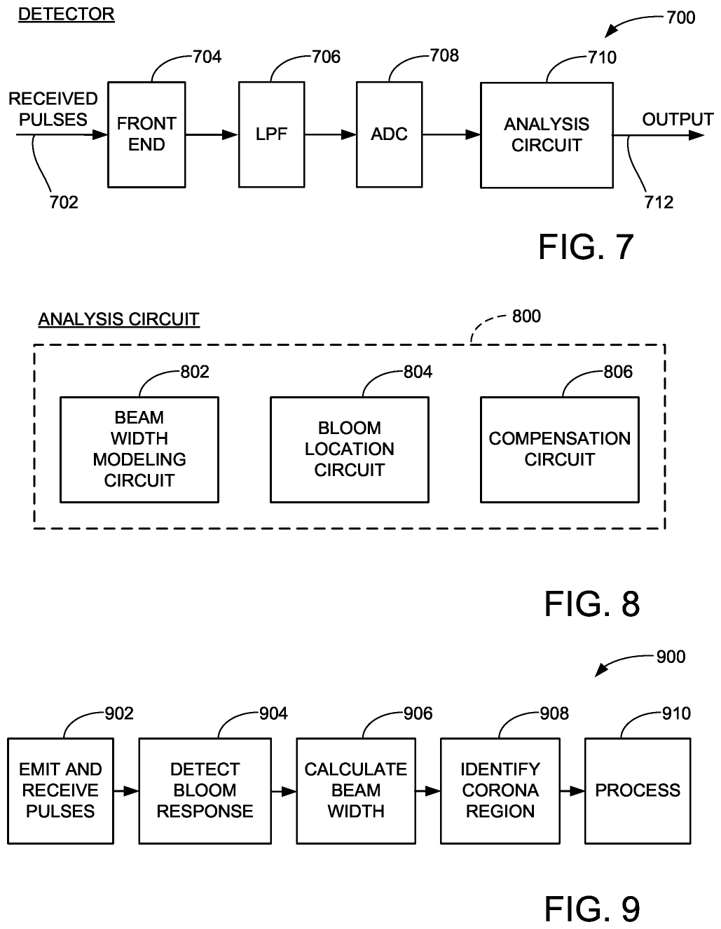

FIG. 7 depicts a detector 700 constructed and operated in accordance with some embodiments, and which corresponds to the detector 108 in FIG. 1. Other configurations for the detector 700 can be used.

Received pulses 702 reflected from an illuminated target are processed by a front end 704. The specific configuration of the front end is not necessarily germane to the present discussion as any number of configurations, including multi-channel detectors, can be used to provide initial processing of the received signal. Elements of the front end 704 can include optics, amplifiers, mixers, etc. A low pass filter (LPF) 706 and analog to digital converter (ADC) 708 process the output from the front end 704.

An analysis circuit 710 receives a digitized output from the ADC 708 and performs analysis operations to detect and compensate for bloom response. This analysis can include identifying measurement points around a retroreflective surface as blooming to allow for special handling/discarding of those measurements.

In some cases, the analysis circuit 710 may operate to first identify a retroreflective surface and then use a model of the beam width to determine which points around the retroreflector are due to blooming. Further compensation efforts can be applied after these determinations. The analysis circuit 710 can be realized in hardware or programmable processor circuits. In some embodiments, at least aspects of the analysis circuit 710 are carried out by program routines stored in the local memory 124 (see FIG. 1) and executed by the processor(s) 122 of the controller 104.

FIG. 8 provides an analysis circuit 800 corresponding to the circuit 710 in FIG. 7 in some embodiments. The circuit 800 includes a beam width modeling circuit 802, a bloom location circuit 804 and a compensation circuit 806. Other arrangements can be used. The modeling circuit 802 estimates or otherwise measures the beam width at the target. This can be carried out in a number of ways. In some cases, based on system parameters the rate of expansion of the beam can be known a priori, and based on an estimate of the distance to the target, the beam width can be established. Measurements of reflected light beams at the detector can also be used; assuming a linear rate of expansion (see e.g., FIG. 6), the beam width of a received pulse can be divided in half (or some other suitable ratio) to estimate the beam width on target. Other mechanisms can be used, including the results of previous calibration testing, etc.

The location circuit 804 divides up the received signal (see e.g., FIGS. 3A, 3B) to discern the boundaries of the bloom response. This can be broken down into units (e.g., pixels) based on the estimated beam width. The compensation circuit 806 thereafter compensates for those aspects of the returned data associated with the bloom response. This can include taking information from the center of the object (e.g., 312, 324), using data outside and surrounding the bloom response (e.g., 314, 326), etc.

The samples that make up the bloom response (e.g., the corona) can be discarded, ignored, subjected to a reduced weighting value, or any other suitable compensation value. By filtering out those units identified as part of the bloom response, based on beam width, remaining aspects of the returned data can be used to provide useful range information.

FIG. 9 provides a sequence diagram 900 for actions taken by the analysis circuits 710, 800 in accordance with various embodiments. Other operations can be utilized in accordance with the present discussion.

Normal operation of the system 100 commences at block 902 in which light beams are emitted towards and received from a down range target, and the signals are processed as described above to decode range information associated with the target.

As shown by block 904, the characteristics of the received light pulses are monitored to detect the presence of a retroflector or other element in the field of view providing a bloom response. This can be carried out as described above such as through a higher than a selected threshold response, size and shape characteristics, duration characteristics, etc. Threshold and averaging circuits can be used to enable the system to confirm the presence of a bloom response and operate to compensate accordingly.

In response to the confirmed detection of a bloom response, a beam width on target is determined at block 906. This can be obtained in a number of ways as described above using the beam width modeling circuit 802. In some cases, the beam width is based on empirical data associated with the known beam spreading characteristics of the system during operation as well as the distance to the target, using previously acquired response data for non-blooming targets during operation, accessing data structures in the local memory that record the results of previous calibration operations that identify beam width at for specific sized targets for various distances, etc. Different types of retroflector responses can be previously characterized and retained by the system for reference.

The bloom response contours (e.g., corona) are identified based on the beam width at block 908. This can be carried out by the bloom location circuit as described above by using the beam width on target as a pixel size. The corona surrounds the actual location of the target (as would be otherwise detected without the bloom response) and is related to, albeit larger, than the underlying target. This operation identifies the general contour of the areas within the field of view at the detector affected by the retroreflector (or other illuminated target providing the bloom response).

Once the corona is identified, further processing is carried out as shown by block 910. This can include normal processing of targets that fall outside the boundaries/pixels identified in block 908, characterization of the underlying target including size, type, position, distance, and other related factors, adjustments to the emitter and/or transmitter as required, and so on.

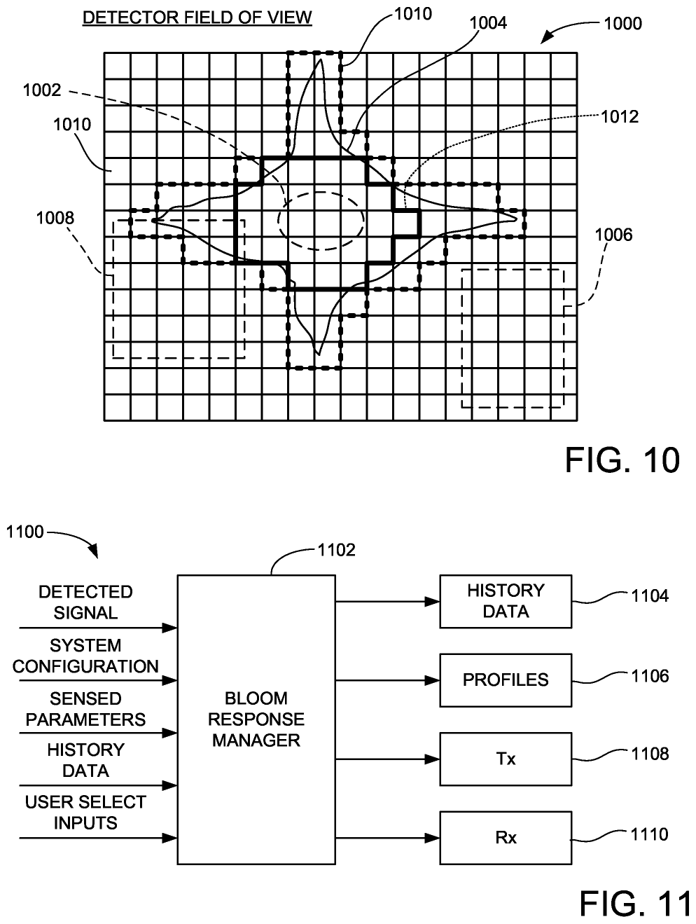

FIG. 10 shows a simplified representation of a portion of a detector field of view 1000 generated and processed in accordance with the sequence 900 of FIG. 9. It will be understood that FIG. 10 is merely exemplary and represents a response from a detector such as 400 obtained from emitted light pulses transmitted from an emitter such as 300. The field of view may be expressed as a data structure of accumulated data from the detector in a memory, such as the local memory 124, as the emitted beam is swept (e.g., rasterized, etc.) down range to illuminate various targets in a direction of interest.

A first target 1002 within the field of view 1000 has a retroreflective characteristic that provides a flared bloom response 1004. A separate, second target 1006 is adjacent the first target albeit outside of the bloom response 1004 and has a normal level of reflectivity. A third target 1008 is also adjacent the first target, but is partially occluded by a portion of the bloom response 1004.

Processing of the response data in FIG. 10 includes the identification of pixels 1010 having a size dimension (e.g., width, length, radius, etc.) that corresponds to the estimated beam size (width) on the first target 1002, that is, the target generating the bloom response.

The pixels 1010 form a grid that can be overlaid onto the field of view to granularize the field of view in known increments. Boundary 1010 represents the outermost extent of the bloom response along pixel boundaries. Because of the flared nature of the bloom, a second boundary 1012 corresponding to the corona region of the image can also be defined.

While the contours of a given corona region will depend on a number of factors including characteristics of the bloom, distance, shape and size of the target, etc., generally the centralized nature of the corona region defined by boundary 1012 provides a general indication of the location, size and extent of the underlying target 1002. In some cases, the respective boundaries 1010 and 1012 can be identified based on relative strength of the signal at the detector. In some embodiments, a lower, first level of saturation can be used to define the outermost boundary 1010 and a second, higher level of saturation can be used to define the corona boundary 1012. Other arrangements can be used.

Once the corona region is determined, a number of compensation techniques can be applied. With respect to the underlying target 1002, an estimated size and range can be obtained using empirical data, a derating value, etc. For example, based on certain types of bloom characteristics it may be determined that the underlying object is centered within the bloom and occupies around 40% or some other percentage of the size of the corona region, etc.

In some embodiments, differently configured emitted pulses, such as at a different frequency, power, shape, etc. can be separately directed to the region corresponding to the bloom response to refine the detection of the retroreflective target. The values for the corona region can further be subjected to different levels of filtering or other processing to extract information associated with the target 1002. External information can be incorporated into the analysis such as geolocation (GPS) or other system inputs to characterize the type of target, such as markers in a construction zone, etc. Finally, depending on the application, some embodiments can simply exclude or otherwise not process any information from within the boundaries 1010 or 1012 during the decoding operation.

Processing of data outside the boundary 1010 can be carried out using conventional mechanisms, including for the second target 1006 and the visible portion of the third target 1008. Range measurements for the third target 1008 can be used to at least frame the distance to the first target 1002 and enable the system, over a number of pulse cycles, to distinguish these respective targets.

FIG. 11 shows a bloom response compensation system 1100 that can be incorporated into the system 100 of FIG. 1 in some embodiments. The system 1100 includes a bloom response manager circuit 1102 that can correspond to the compensation circuit 806 in FIG. 8 and carry out compensation operations as described above. In some embodiments, the manager circuit 1102 comprises a firmware routine stored in the local memory 124 and executed by the controller processor 122 (FIG. 1).

The manager circuit 1102 uses a number of inputs including the detected signal data from FIG. 10, system configuration information, various sensed operational and environmental parameters from the system (including from external sensors 126), history and calibration data accumulated during prior operation, and user selectable inputs to enable different modes of operation. Other inputs can be used as desired.

The manager circuit 1102 uses these and other inputs to provide various outputs including accumulated history data 1104 and various profiles 1106, both of which can be stored in local memory such as 124 for future reference. The history data 1104 can be arranged as a data structure providing relevant history and system configuration information. The profiles 1106 can describe different pulse set configurations with different numbers of pulses at various frequencies, different thresholds and other configuration settings that can be implemented during detection operations, and any other useful information that may be referenced during the evaluation of a bloom response.

The manager circuit 1102 further operates to direct various control information to an emitter (transmitter Tx) 1108 and a detector (receiver Rx) 1110 to process and compensate the detected bloom response. It will be understood that the Tx and Rx 1108, 1110 correspond to the various emitters and detectors described above.

In this way, targets with retroreflective surfaces or that otherwise provide saturated/high reflectivity responses can be compensated, based on beam width, allowing useful range information to be obtained. It is therefore not necessary for the system to simply ignore and cancel out the data associated with the bloom response, which could be detrimental in a number of applications.

Finally, because of the pulsed nature of the bloom response detection techniques discussed herein, the system can readily distinguish between a bloom response caused by reflected light from the emitter and other types of responses, such as camera flares, etc. that are generated by an external source (e.g., oncoming vehicle headlights, the morning/evening sun, etc.). The response characteristics will tend to be different between these respective inputs; a bloom response will tend to change with the application of different levels and types of emitted pulses, while an external source will provide the same input to the detector independently of the operation of the emitter. Thus, part of the verification operation in identifying a bloom response can further include providing a sequence of reduced power pulses and detecting changes in the bloom response.

While coherent, I/Q based systems have been contemplated as a basic environment in which various embodiments can be practiced, such are not necessarily required. Rather, any number of different types of systems can be employed, including non-coherent pulsed systems, etc. The terms bloom, bloom event, bloom response and the like will be understood consistent with the foregoing discussion to describe the phenomena described above when a highly reflective target, such as but not limited to a retroreflector, provides an anomalous response at the detector level.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method, comprising:
detecting a bloom event responsive to a sequence of emitted light pulses against a target;
determining a beam width of the emitted light pulses on the target; and
using the determined beam width to compensate a portion of the bloom event to obtain range information associated with the target.

2. The method of claim 1, wherein the bloom event is detected by a detector in relation to a step-wise detector signal strength differential along an outermost boundary of the bloom event within a field of view of the detector.

3. The method of claim 1, wherein the bloom event is characterized as a discontinuous response having a central corona region that surrounds and extends beyond the target in a field of view of a detector, the discontinuous response further having one or more elongated areas that extend from the central corona region, and wherein the method further comprises determining a size of the central corona region responsive to the beam width.

4. The method of claim 1, wherein the bloom event is characterized as a continuous response having a central corona region that surrounds and extends beyond the target in a field of view of the detector, and wherein the method further comprises determining a size of the central corona region responsive to the beam width.

5. The method of claim 1, further comprising determining the beam width as a dimension of a cross-sectional area of the emitted light pulses upon a surface of the target, and using the beam width to define pixel areas in a field of view of a detector that receives reflected light pulses from the target responsive to the emitted light pulses.

6. The method of claim 1, further comprising emitting a second set of emitted pulses to the target with pulse characteristics selected responsive to the detected range information.

7. The method of claim 1, wherein the bloom event is generated responsive to the emitted light pulses impinging and being reflected back from a retroreflector.

8. The method of claim 1, further comprising determining the bloom event is generated responsive to the emitted light pulses by subsequently emitting subsequent sets of light pulses with different pulse characteristics and detecting corresponding changes in signal strength of the bloom event.

9. An apparatus comprising:
an emitter configured to use a light source to illuminate a target with emitted pulses;
a detector configured to receive reflected pulses from the target; and
a controller circuit configured to detect a bloom response in the reflected pulses, detect a beam width of the emitted pulses on the target, identify a corona region of the bloom response surrounding the target using the beam width, and determine range information associated with the target using the identified corona region.

10. The apparatus of claim 9, wherein the controller circuit detects the bloom response in relation to changes in detector signal strength along an outermost boundary of the bloom response in a field of view of the detector.

11. The apparatus of claim 9, wherein the target is characterized as a retroreflector that provides efficient reflectivity of the emitted pulses at a level significantly higher than a non-retroreflector based second target adjacent the first target, and wherein the controller circuit determines a first distance from the detector to the retroreflector and a different, second distance from the detector to the second target.

12. The apparatus of claim 9, wherein the controller circuit determines the beam width responsive to an estimated range distance between the detector and the target and a predetermined beam spreading rate of the light source.

13. The apparatus of claim 9, wherein the controller circuit uses the beam width to define a grid of pixels across a field of view of the detector and generates a boundary of said pixels in which the corona region is defined, wherein the controller circuit applies a first type of processing to the received pulses within the boundary and a different, second type of processing to the received pulses outside the boundary.

14. The apparatus of claim 9, wherein the controller circuit directs the emitter to send second emitted pulses with adjusted pulse characteristics responsive to the determined range information to the target to refine the determined range information.

15. A light detection and ranging (LiDAR) system, comprising:
an emitter comprising a modulation circuit, a light source and an output system to emit a set of emitted pulses onto a target at a selected range distance from the emitter;
a detector comprising an optical front end, a low pass filter (LPF), an analog-to-digital converter to generate a detector output comprising a digital representation of a corresponding set of reflected pulses received from the target; and
an analysis circuit configured to detect a bloom response in the detector output in relation to changes in signal levels in the detector output, to determine an estimated beam width of the emitted pulses on the target from the emitter and to use the estimated beam width to identify a size of a corona region of the bloom response, and to determine the selected range distance using the identified size of the corona region.

16. The LiDAR system of claim 15, wherein the analysis circuit comprises a beam width modeling circuit that estimates the beam width in relation to a beam spreading characteristic of the light source, a bloom location circuit which identifies pixels determined from the estimated beam width to generate a boundary of the corona region, and a compensation circuit that characterizes the target in relation to the size of the corona region.

17. The LiDAR system of claim 15, wherein the output system of the emitter comprises a rotatable polygon which sweeps the emitted pulses over a predetermined area downrange towards the target, and wherein the detector output corresponds to a field of view that incorporates the predetermined area.

18. The LiDAR system of claim 15, wherein the output system of the emitter comprises an integrated circuit device characterized as a solid state array which sweeps the emitted pulses over a predetermined area downrange towards the target, and wherein the detector output corresponds to a field of view that incorporates the predetermined area.

19. The LiDAR system of claim 15, wherein the controller circuit concurrently decodes a second range distance between the emitter and a second target in non-overlapping relation to the bloom response from the detector output.

20. The LiDAR system of claim 15, wherein the bloom response is generated responsive to the emitted light pulses impinging and being reflected back from a retroreflector.
